(19) United States
(12) Patent Application Publication
(10) Pub. No.: US 2011/0296030 A1
(43) Pub. Date: Dec. 1, 2011

(54) SINGLE RUI RENDERER ON A VARIETY OF DEVICES WITH DIFFERENT CAPABILITIES

(75) Inventor: David G. Gaxiola, San Jose, CA (US)

(73) Assignee: SONY CORPORATION, Tokyo (JP)

(21) Appl. No.: 12/786,832

(22) Filed: May 25, 2010

(51) Int. Cl. G06F 3/01; G06F 15/16

(52) U.S. Cl. 709/227; 715/744

(57) ABSTRACT

Remote user interface rendering devices are able to adaptively degrade the user experience in a manner that is predictable utilizing the method and system described. Capability groups used are a set of interrelated functionalities that are supported as a whole by the rendering device. If the rendering device does not support any feature in a capability group, the remaining features in the same capability group are automatically disabled for the rendering device. The capability groups are able to be assigned priorities so that higher priority capability groups are evaluated first.

### FIELD OF THE INVENTION

The present invention relates to the field of remote user interfaces. More specifically, the present invention relates to a remote user interface renderer with varying capabilities.

### BACKGROUND OF THE INVENTION

The number of electronic devices in people's homes is continually increasing. Many years ago, homes only had a radio; then, a radio and a television. The number of devices has increased to the point where a typical home has several televisions, stereos, computers, video game consoles, mobile phones/devices, appliances and others. Furthermore, these devices are gaining intelligence so that they are able to communicate with each other.

The expansion of residential networks to include a multiplicity of devices that can share files asynchronously and connect to the Internet through residential gateways was facilitated by the de-facto standard use of wired and wireless ethernet connectivity. Asynchronous sharing then started to give way to buffered streaming of video as bandwidth availability improved. This was closely followed by real time streaming. Networks employ quality of service to manage bandwidth resources and Universal Plug and Play (UPnP) to perform discovery and compatibility of compressed video content. Video UPnP also defines remote user input operation like play, stop and rewind so that video control as well as video display is able to be performed remotely. Also, provisions were made to support graphical transfer of a remote user interface, but no implementations on the market have made use of this. UPnP allowed for many different standards of compressed video but does not, however, certify that a client supported the relevant decoder. Digital Living Network Alliance (DLNA) is a standards body formed to provide certified device compatibility for a specific subset of UPnP implementations. DLNA also defined the role of media servers, renderers, adapters, players and controllers.

A standard, referred to as Remote User Interface (RUI or Remote UI) is being developed to allow devices to operate each other and provide the user with a user interface that is configured appropriately for a device being used to control another device. For example, a user interface for a 46″ wide television is not likely to appear properly on a mobile phone which has a display of 2″. The Remote UI standard is a web-based protocol and framework for remote user interface on UPnP Networks and the Internet. The standard allows a UPnP-capable home network device to provide its interface (display and control options) as a web page to display on any other device coupled to the home network.

There are no well defined and widely accepted UPnP implementations for graphical RUI. One option, which has been backed by the UPnP Forum, is a browser based implementation known as CEA2014. The network client browser is considered to be heavy in flash, memory and/or processor requirements (‘thick’ client), whereas the network server application performs simple encapsulation of XML (‘thin’ server). In some situations this may be acceptable, like the case when rendering is performed by a personal computer and the application is run on a small mobile device, or a low end processing device, like a network router.

However, in the case of the home network where the rendering is done by a high definition TV, a Blu-Ray® player, a picture frame or a gaming machine, the use of a browser for RUI has some disadvantages. Firstly, a browser adds to the already substantial memory requirements of the renderers and so for these cost sensitive consumer electronics devices it may not be viable. Secondly, the processing requirements for a responsive experience are not going to be uniformly provided by the current range of available devices since some devices have hardware that other devices do not have. And thirdly, the browser interface lends itself well to mouse and keyboard control, but is not necessarily the ideal format for a limited button remote control.

Also, the home network is able to include graphics applications built into game machines, video players, dongles and intelligent remotes on the low end, with cable boxes, cloud servers and multimedia PCs on the high end. To shoehorn all of these into one UPnP standard, it is clear that reach will be limited. In some cases substantial effort of rewriting or translation of the graphics application might be needed in order to fit the browser framework.

Another example of a proposed RUI is being provided through the RVU alliance. The RVU alliance was initiated by DIRECTV in order to provide a pixel accurate remotely rendered version of their satellite decoder user interface. This type of RUI would be considered a thin network client and thick network server because most of the computation effort would be with the application. Also, because most actions involve sending image data, this type of RUI uses a lot of network resources.

The advantage of RVU is that it is able to be supported by all graphics cards quite easily and is not directly dependent on the type of application to be able to function. However, sometimes performance is a key parameter in usability, and as such the network load and network server performance could severely limit how useful the protocol is. RVU is especially vulnerable where complete screen refreshes are needed often, like 3D rotations of a view. A browser approach could handle this more simply through scripts of simple rotation commands. Another similar limitation is when the application is providing remote graphics to multiple renderers, and causes the application processor to run short of the necessary processing cycles to perform adequately.

### SUMMARY OF THE INVENTION

Remote user interface rendering devices are able to adaptively degrade the user experience in a manner that is predictable utilizing the method and system described. Capability groups used are a set of interrelated functionalities that are supported as a whole by the rendering device. If the rendering device does not support any feature in a capability group, the remaining features in the same capability group are automatically disabled for the rendering device. The capability groups are able to be assigned priorities so that higher priority capability groups are evaluated first.

In one aspect, a method of rendering a remote user interface on a device comprises providing a set of capability groups to a rendering device, determining if a capability group of the set of capability groups is supported by the device and rendering the remote user interface using the capability group. The method further comprises establishing a session between a server and the rendering device. The set of capability groups are contained within a remote user interface description. The determining is by the rendering device. The determining is by a user. The set of capability groups is prioritized. The set of capability groups is prioritized by one of narrow to broad, advanced to basic and varying effects. The device checks each capability group of the set of capability groups in an order selected from narrow to broad, advanced to basic and varying effects. If the device does not support a feature in the capability group, the device does not implement the capability group. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In another aspect, a network of devices for rendering a remote user interface on multiple devices comprises a server for storing a set of capability groups and distributing the set of capability groups, a rendering device for rendering the remote user interface using the set of capability groups and an input device for sending the remote user interface to the rendering device. The server and the rendering device establish a session to transfer the set of capability groups. The set of capability groups are contained within a remote user interface description which is included with the remote user interface. The rendering device determines which capability group is supported by the rendering device. A user determines which capability group is supported by the rendering device. The set of capability groups is prioritized. The set of capability groups is prioritized by one of narrow to broad, advanced to basic and varying effects. The rendering device checks each capability group of the set of capability groups in an order selected from narrow to broad, advanced to basic and varying effects. If the rendering device does not support a feature in a capability group, the rendering device does not implement the capability group. The server, the rendering device and the input device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In another aspect, a system programmed in a controller in a device comprises a session module for establishing a session with a server device and a capability group implementation module for using a set of capability groups to render a remote user interface. The session is used to transfer the set of capability groups. The capability group implementation module is for determining which capability group is supported. The set of capability groups is prioritized. The set of capability groups is prioritized by one of narrow to broad, advanced to basic and varying effects. Each capability group of the set of capability groups is checked in an order selected from narrow to broad, advanced to basic and varying effects. If a feature is not supported in a capability group, the capability group is not implemented.

In yet another aspect, a server device comprises a memory for storing an application, the application for storing a set of capability groups, establishing a session with a rendering device and transferring the set of capability groups to the rendering device and a processing component coupled to the memory, the processing component for processing the application. The session is used to transfer the set of capability groups. The set of capability groups is prioritized. The set of capability groups is prioritized by one of narrow to broad, advanced to basic and varying effects. Each capability group of the set of capability groups is checked in an order selected from narrow to broad, advanced to basic and varying effects.

In another aspect, a rendering device comprises a memory for storing an application, the application for receiving a remote user interface and a set of capability groups, determining if a capability group of the set of capability groups is supported and rendering the remote user interface using the capability group and a processing component coupled to the memory, the processing component for processing the application. The application is further for establishing a session with a server. The set of capability groups are contained within a remote user interface description. The determining is by the application on the rendering device. The determining is by a user. The set of capability groups is prioritized. The set of capability groups is prioritized by one of narrow to broad, advanced to basic and varying effects. The application checks each capability group of the set of capability groups in an order selected from narrow to broad, advanced to basic and varying effects. If the application does not support a feature in the capability group, the application does not implement the capability group.

### BRIEF DESCRIPTION OF THE DRAWINGS

FIG. 1 illustrates a block diagram of a network of devices implementing a method of utilizing a single RUI on a variety of devices according to some embodiments.

FIG. 2 illustrates a flowchart of a method of utilizing an RUI on a variety of devices according to some embodiments.

FIG. 3 illustrates a block diagram of an exemplary computing device according to some embodiments.

### DETAILED DESCRIPTION OF THE PREFERRED EMBODIMENT

Remote User Interface (RUI) servers do not always reliably know actual capabilities of a rendering device. Rendering devices are also able to misrepresent their compatibility level during discovery or have only partial support for features. A server of RUIs is also able to have outdated device profile information. These potential issues challenge an RUI server to reliably determine and provide targeted user interfaces to all potential rendering devices.

A method to enable a single RUI description to be rendered on a variety of devices with different capabilities with a controlled adaptation level of degradation by conveying an RUI to devices with a set of features or capabilities grouped into prioritized profiles is described. Unsupported features at higher priorities effectively disables other features in the same priority group.

Rendering devices are able to adaptively degrade the user experience in a manner that is able to be predetermined by original user interface designers and not with unpredictable or problematic results.

During initial session establishment between an RUI server and a rendering device or in the RUI description itself, the RUI server provides to the rendering device a set of capability groups. These capability groups include a set of interrelated functionality that is supported as a whole. The granularity of the functional group is able to vary from a high level feature (e.g. “render text” or “background HTTP request”) to an individual parameter/attribute of the feature (e.g. specific font families or specific visual blending options). If a rendering device determines or the user decides that a feature in a capability group is not supported by the rendering device, then the other features in that capability group are not used. In some embodiments, the user is an end-user such as a person watching a television, and in some embodiments, the user is another person such as a content author who chooses the grouping and ordering of features. In some embodiments, the capability groups themselves are able to be prioritized so that high priority group capabilities are evaluated first, allowing user interface-author specified degradation of capabilities. The user interface author considers and tests the impact of unsupported group features. This approach leans towards thick clients where there is some user interface description plus executable logic which constitutes the user interface but should be acceptable to thin clients which are driven by a set of invoked application programming interfaces and pushed presentations.

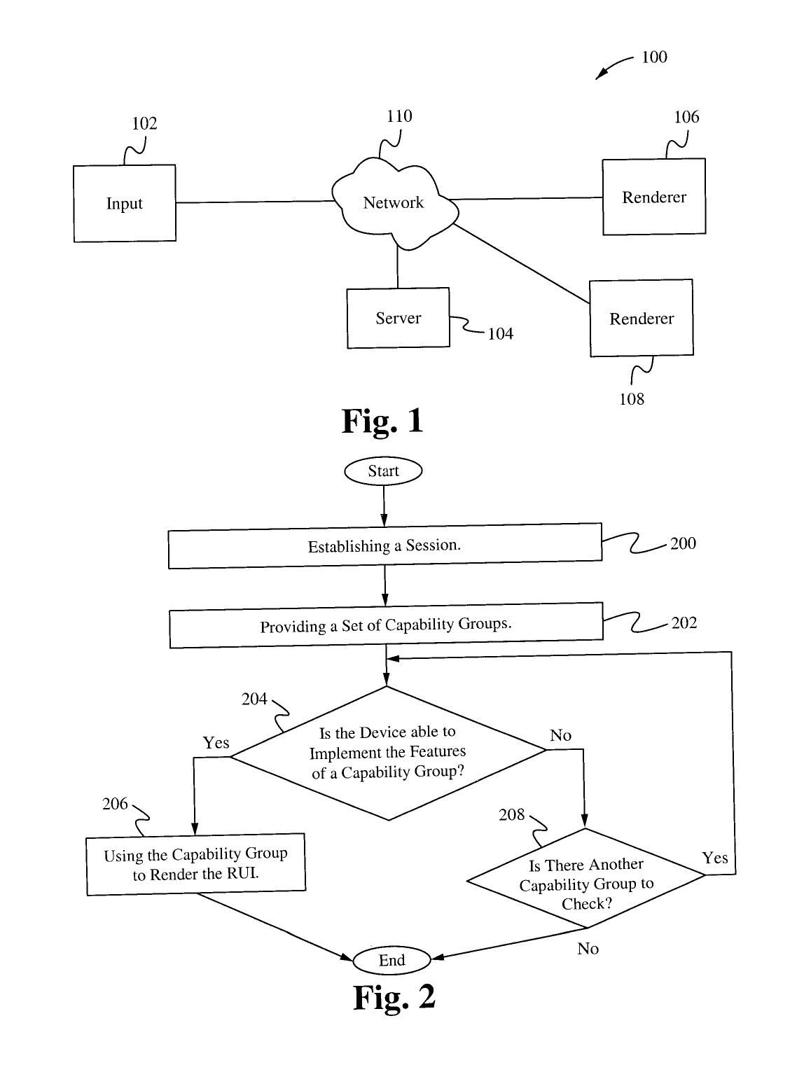

FIG. 1 illustrates a block diagram of a network of devices implementing a method of utilizing a single RUI on a variety of devices according to some embodiments. The network of devices 100 includes one or more input devices 102 coupled to a server device 104 and one or more rendering devices (e.g. a television) 106 and 108. In some embodiments, the input device 102, the server device 104 and the rendering devices 106 and 108 are coupled directly, and in some embodiments, the input device 102, the server device 104 and the rendering devices 106 and 108 are coupled through a network 110. The network 110 is able to be any type of network including, but not limited to, a LAN, a WAN, the Internet, a cellular network, a wireless network, a wired network and/or any combination thereof.

The input device 102 is any device that sends RUI data such as RUI commands to a rendering device 106. In some embodiments, the RUI data is sent to a server device 104 which processes the RUI data and then sends the processed data to the rendering device 106. In some embodiments, the input device 102 also receives processed RUI data from the server device 104.

The server device 104 is any device that is able to serve an RUI to the rendering devices 106 and 108. The server device 104 is able to run one or more applications to provide the RUI data and accept RUI commands from the input device 102. The server device 104 also provides a set of capability groups to the rendering devices 106 and 108. Each of the capability groups is a set of interrelated functionality.

The rendering devices 106 and 108 are each any device that is able to render and display the RUI data, for example, a television displaying an RUI. The rendering devices 106 and 108 each receive a set of capability groups. The rendering devices 106 and 108 determine if each is able to support the features in a capability group. If any feature of the capability group is not supported by the rendering device, then that feature and other features in that capability group are not used by that rendering device. In some embodiments, other capability groups are checked if one fails until an appropriate group is found supporting all of the features. In some embodiments, if a device does not support any capability group, then the features of that capability group are not implemented. In some embodiments, the capability groups are assigned priority such that high priority groups are evaluated first.

As an example, the rendering device 106 is able to implement a feature set of ABC, and the rendering device 108 is able to implement a feature set of ABD. If a capability group includes AB, then both the rendering device 106 and 108 are able to implement those features. However, if the capability group includes AC, then the rendering device 106 is able to implement those features, but the rendering device 108 is not.

In another example, as described, the capability groups are able to be arranged in a narrow to broad order, so that narrow capability groups are analyzed before the broad capability groups. Narrow capability groups are very focused on specific applications whereas broad capability groups are more generalized. For example, the capability groups are prioritized: ABCD, ABC, AB, A. A device that is able to implement the features ABC would not be able to utilize the ABCD capability group since D is not supported by the device but would be able to utilize the ABC capability group as all of those features are supported.

In some embodiments, the groups are arranged from advanced to basic so that advanced capability groups are analyzed before the more basic capability groups. In some embodiments, the groups are prioritized for cosmetic and functional implementations. For instance, one group includes three dimensional effects while another group relies on transparency effects and yet another group uses time-based scripting for animation and other effects.

FIG. 2 illustrates a flowchart of a method of utilizing an RUI on a variety of devices according to some embodiments. In the step 200, a session is established between an RUI server and one or more rendering devices. In the step 202, a set of capability groups are provided to the rendering devices. In the step 204, it is determined if a device is able to implement all features of a capability group. In the step 206, if the device is able to implement all features of the capability group, then that capability group is used to render the RUI. In some embodiments, in the step 208, if the device is not able to implement all of the features of the capability group, it is determined if there are other capability groups to check. If there are other capability groups to check, then the next one is checked again in the step 204. If there are no other capability groups to check, then the process concludes and the feature is not implemented. The capability groups are able to be configured in a priority order such as so that a most specific capability group is checked first and the capability groups broaden as the process repeats. In some embodiments, several capability groups are utilized to implement features. For example, if the device is capable of implementing features A and B, but there is no single capability group that the device supports, but the device does support two separate capability groups, one including A and one including B, then the two separate groups are able to be utilized. Although specific steps are described, in some embodiments, fewer or more steps are included, and/or the order of the steps is able to be changed.

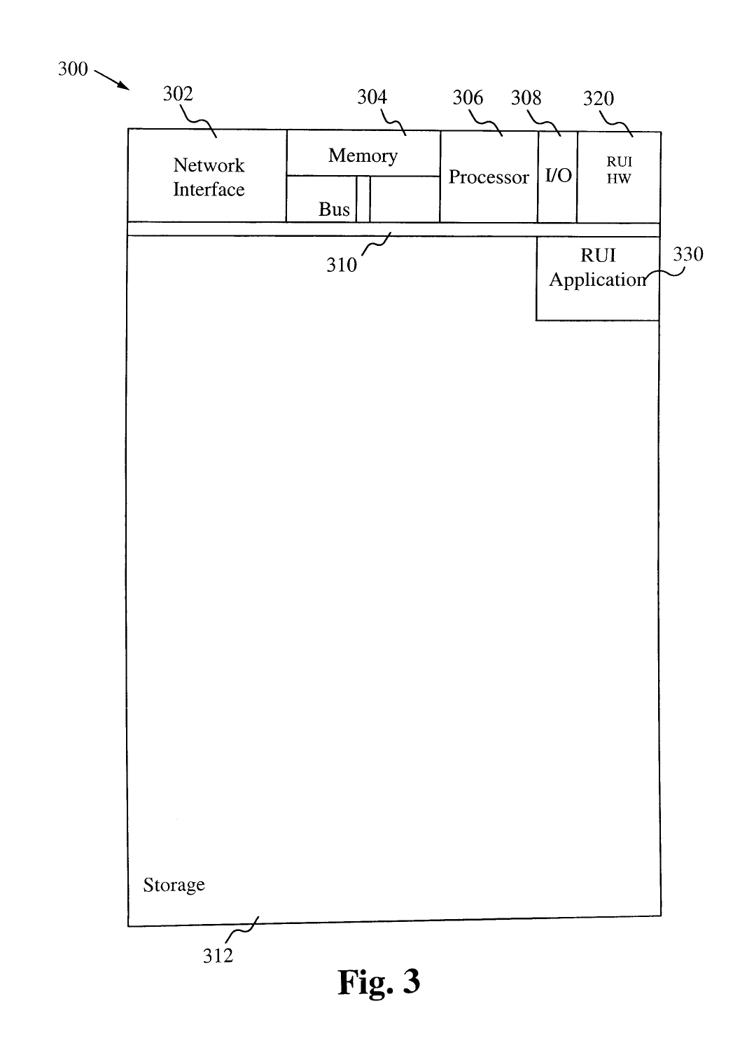

FIG. 3 illustrates a block diagram of an exemplary computing device 300 according to some embodiments. The computing device 300 is able to be used to acquire, store, compute, communicate, transfer and/or display information. For example, the computing device 300 is able to serve, store and/or utilize a set of capability groups to enable an RUI to be rendered on a variety of devices. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, Blu-ray®, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, display, printer, modem, touchscreen, button interface and other devices. RUI application(s) 330 used to serve, store and/or utilize the set of capability groups are likely to be stored in the storage device 312 and memory 304 and processed as applications are typically processed. More or less components shown in FIG. 3 are able to be included in the computing device 300. In some embodiments, RUI hardware 320 is included. Although the computing device 300 in FIG. 3 includes applications 330 and hardware 320, the RUI operations are able to be implemented on a computing device in hardware, firmware, software or any combination thereof. For example, in some embodiments, the RUI applications 330 are programmed in a memory and executed using a processor. In another example, in some embodiments, the RUI hardware 320 is programmed hardware logic including gates specifically designed to implement the remote user interface adapter operations.

In some embodiments, the RUI application(s) 330 include several applications and/or modules. As described herein, the RUI application(s) 330 include a session module for establishing a session, a capability group provider module for providing a set of capability groups and a capability group implementation module for using the capability groups to render the RUI. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-ray® writer/player, a television, a home entertainment system or any other suitable computing device. In some embodiments, a computing device is able to include intelligent appliances such as a refrigerator, a toaster, a toaster oven and a microwave, where the appliances are able to process and/or present information.

The computing device is able to be implemented as an input device, a server device or a rendering device.

To utilize the RUI method of using a set of capability groups, a user uses an input device to control one or more rendering devices, and an RUI is displayed on the rendering devices. Instead of generating multiple RUIs to be distributed and selecting which RUI is usable with which rendering device, a server is able to send the set of capability groups with the RUI. The capability groups enable the rendering device to implement features of the RUI that are supported by the rendering device, and the capability groups prevent features from being implemented if any features in a capability group are not able to be implemented by the device. The result is an RUI being displayed on a device properly. Furthermore, the same RUI is able to be sent to varying devices and although the RUI is able to appear different depending on the devices' capabilities, the same RUI is able to be utilized.

In operation, the RUI using a set of capability groups enables a variety of devices with disparate capabilities to utilize the same RUI. The capability groups include groups of capabilities or features that stand or fall together such that if a capability is not supported by the device, then the capability group is not implemented.

In some embodiments, the devices implemented within the network described herein are able to implement Digital Living Network Alliance (DLNA) standard, UPnP and/or the Remote UI standard. In some embodiments, the devices implemented within the network described herein do not implement Digital Living Network Alliance (DLNA) standard, UPnP and/or the Remote UI standard.

Some Embodiments of Single RUI Renderer on a Variety of Devices with Different Capabilities
1. A method of rendering a remote user interface on a device comprising:
   a. providing a set of capability groups to a rendering device;
   b. determining if a capability group of the set of capability groups is supported by the device; and
   c. rendering the remote user interface using the capability group.
2. The method of clause 1 further comprising establishing a session between a server and the rendering device.
3. The method of clause 1 wherein the set of capability groups are contained within a remote user interface description.
4. The method of clause 1 wherein the determining is by the rendering device.
5. The method of clause 1 wherein the determining is by a user.
6. The method of clause 1 wherein the set of capability groups is prioritized.
7. The method of clause 1 wherein the set of capability groups is prioritized by one of narrow to broad, advanced to basic and varying effects.
8. The method of clause 1 wherein the device checks each capability group of the set of capability groups in an order selected from narrow to broad, advanced to basic and varying effects.
9. The method of clause 1 wherein if the device does not support a feature in the capability group, the device does not implement the capability group.
10. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
11. A network of devices for rendering a remote user interface on multiple devices comprising:
   a. a server for storing a set of capability groups and distributing the set of capability groups;
   b. a rendering device for rendering the remote user interface using the set of capability groups; and
   c. an input device for sending the remote user interface to the rendering device.
12. The network of devices of clause 11 wherein the server and the rendering device establish a session to transfer the set of capability groups.
13. The network of devices of clause 11 wherein the set of capability groups are contained within a remote user interface description which is included with the remote user interface.
14. The network of devices of clause 11 wherein the rendering device determines which capability group is supported by the rendering device.
15. The network of devices of clause 11 wherein a user determines which capability group is supported by the rendering device.
16. The network of devices of clause 11 wherein the set of capability groups is prioritized.
17. The network of devices of clause 11 wherein the set of capability groups is prioritized by one of narrow to broad, advanced to basic and varying effects.
18. The network of devices of clause 11 wherein the rendering device checks each capability group of the set of capability groups in an order selected from narrow to broad, advanced to basic and varying effects.
19. The network of devices of clause 11 wherein if the rendering device does not support a feature in a capability group, the rendering device does not implement the capability group.
20. The network of devices of clause 11 wherein the server, the rendering device and the input device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
21. A system programmed in a controller in a device comprising:
   a. a session module for establishing a session with a server device; and
   b. a capability group implementation module for using a set of capability groups to render a remote user interface.
22. The system of clause 21 wherein the session is used to transfer the set of capability groups.
23. The system of clause 21 wherein the capability group implementation module is for determining which capability group is supported.
24. The system of clause 21 wherein the set of capability groups is prioritized.
25. The system of clause 21 wherein the set of capability groups is prioritized by one of narrow to broad, advanced to basic and varying effects.
26. The system of clause 21 wherein each capability group of the set of capability groups is checked in an order selected from narrow to broad, advanced to basic and varying effects.
27. The system of clause 21 wherein if a feature is not supported in a capability group, the capability group is not implemented.
28. A server device comprising:
   a. a memory for storing an application, the application for:
      i. storing a set of capability groups;
      ii. establishing a session with a rendering device; and
      iii. transferring the set of capability groups to the rendering device; and
   b. a processing component coupled to the memory, the processing component for processing the application.
29. The server device of clause 28 wherein the session is used to transfer the set of capability groups.
30. The server device of clause 28 wherein the set of capability groups is prioritized.
31. The server device of clause 28 wherein the set of capability groups is prioritized by one of narrow to broad, advanced to basic and varying effects.
32. The server device of clause 28 wherein each capability group of the set of capability groups is checked in an order selected from narrow to broad, advanced to basic and varying effects.
33. A rendering device comprising:
   a. a memory for storing an application, the application for:
      i. receiving a remote user interface and a set of capability groups;
      ii. determining if a capability group of the set of capability groups is supported; and
      iii. rendering the remote user interface using the capability group; and
   b. a processing component coupled to the memory, the processing component for processing the application.
34. The rendering device of clause 33 wherein the application is further for establishing a session with a server.
35. The rendering device of clause 33 wherein the set of capability groups are contained within a remote user interface description.
36. The rendering device of clause 33 wherein the determining is by the application on the rendering device.
37. The rendering device of clause 33 wherein the determining is by a user.
38. The rendering device of clause 33 wherein the set of capability groups is prioritized.
39. The rendering device of clause 33 wherein the set of capability groups is prioritized by one of narrow to broad, advanced to basic and varying effects.
40. The rendering device of clause 33 wherein the rendering device checks each capability group of the set of capability groups in an order selected from narrow to broad, advanced to basic and varying effects.
41. The rendering device of clause 33 wherein if the application does not support a feature in the capability group, the application does not implement the capability group.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of rendering a remote user interface on a device comprising:
a. providing a set of capability groups to a rendering device;
b. determining if a capability group of the set of capability groups is supported by the device; and
c. rendering the remote user interface using the capability group.

2. The method of claim 1 further comprising establishing a session between a server and the rendering device.

3. The method of claim 1 wherein the set of capability groups are contained within a remote user interface description.

4. The method of claim 1 wherein the determining is by the rendering device.

5. The method of claim 1 wherein the determining is by a user.

6. The method of claim 1 wherein the set of capability groups is prioritized.

7. The method of claim 1 wherein the set of capability groups is prioritized by one of narrow to broad, advanced to basic and varying effects.

8. The method of claim 1 wherein the rendering device checks each capability group of the set of capability groups in an order selected from narrow to broad, advanced to basic and varying effects.

9. The method of claim 1 wherein if the device does not support a feature in the capability group, the device does not implement the capability group.

10. The method of claim 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

11. A network of devices for rendering a remote user interface on multiple devices comprising:
a. a server for storing a set of capability groups and distributing the set of capability groups;
b. a rendering device for rendering the remote user interface using the set of capability groups; and
c. an input device for sending the remote user interface to the rendering device.

12. The network of devices of claim 11 wherein the server and the rendering device establish a session to transfer the set of capability groups.

13. The network of devices of claim 11 wherein the set of capability groups are contained within a remote user interface description which is included with the remote user interface.

14. The network of devices of claim 11 wherein the rendering device determines which capability group is supported by the rendering device.

15. The network of devices of claim 11 wherein a user determines which capability group is supported by the rendering device.

16. The network of devices of claim 11 wherein the set of capability groups is prioritized.

17. The network of devices of claim 11 wherein the set of capability groups is prioritized by one of narrow to broad, advanced to basic and varying effects.

18. The network of devices of claim 11 wherein the rendering device checks each capability group of the set of capability groups in an order selected from narrow to broad, advanced to basic and varying effects.

19. The network of devices of claim 11 wherein if the rendering device does not support a feature in a capability group, the rendering device does not implement the capability group.

20. The network of devices of claim 11 wherein the server, the rendering device and the input device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

21. A system programmed in a controller in a device comprising:
a. a session module for establishing a session with a server device; and
b. a capability group implementation module for using a set of capability groups to render a remote user interface.

22. The system of claim 21 wherein the session is used to transfer the set of capability groups.

23. The system of claim 21 wherein the capability group implementation module is for determining which capability group is supported.

24. The system of claim 21 wherein the set of capability groups is prioritized.

25. The system of claim 21 wherein the set of capability groups is prioritized by one of narrow to broad, advanced to basic and varying effects.

26. The system of claim 21 wherein the rendering device checks each capability group of the set of capability groups in an order selected from narrow to broad, advanced to basic and varying effects.

27. The system of claim 21 wherein if a feature is not supported in a capability group, the capability group is not implemented.

28. A server device comprising:
a. a memory for storing an application, the application for:
i. storing a set of capability groups;
ii. establishing a session with a rendering device; and
iii. transferring the set of capability groups to the rendering device; and
b. a processing component coupled to the memory, the processing component for processing the application.

29. The server device of claim 28 wherein the session is used to transfer the set of capability groups.

30. The server device of claim 28 wherein the set of capability groups is prioritized.

31. The server device of claim 28 wherein the set of capability groups is prioritized by one of narrow to broad, advanced to basic and varying effects.

32. The server device of claim 28 wherein the rendering device checks each capability group of the set of capability groups in an order selected from narrow to broad, advanced to basic and varying effects.

33. A rendering device comprising:
a. a memory for storing an application, the application for:
i. receiving a remote user interface and a set of capability groups;
ii. determining if a capability group of the set of capability groups is supported; and
iii. rendering the remote user interface using the capability group; and
b. a processing component coupled to the memory, the processing component for processing the application.

34. The rendering device of claim 33 wherein the application is further for establishing a session with a server.

35. The rendering device of claim 33 wherein the set of capability groups are contained within a remote user interface description.

36. The rendering device of claim 33 wherein the determining is by the application on the rendering device.

37. The rendering device of claim 33 wherein the determining is by a user.

38. The rendering device of claim 33 wherein the set of capability groups is prioritized.

39. The rendering device of claim 33 wherein the set of capability groups is prioritized by one of narrow to broad, advanced to basic and varying effects.

40. The rendering device of claim 33 wherein the rendering device checks each capability group of the set of capability groups in an order selected from narrow to broad, advanced to basic and varying effects.

41. The rendering device of claim 33 wherein if the application does not support a feature in the capability group, the application does not implement the capability group.
